(19) United States
(12) Patent Application Publication
(10) Pub. No.: US 2007/0067442 A1
(43) Pub. Date: Mar. 22, 2007

(54) System and method for automatically providing information about a new device to be integrated within a current system configuration

(76) Inventor: Louis Lippincott, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/233,830

(22) Filed: Sep. 22, 2005

(51) Int. Cl. G06F 15/16

(52) U.S. Cl. 709/224; 709/206

(57) ABSTRACT

A method and system for automatically providing information about a new device to be integrated within a current system configuration are described. The method may involve receiving a new device email notification, where the new device email notification is automatically generated at a store when a user purchases a new device. The method may involve validating the new device email notification, identifying the new device via the new device email notification and providing a new device greeting and/or information about the identified new device.

### BACKGROUND

Most manufacturers of the consumer electronic device industry spend a lot of effort and money trying to add new features to its consumer electronic devices. Unfortunately, the average person who purchases a new electronic device never knows or learns to use all of the features an electronic device provides. In an attempt to ensure users learn and understand a new device, manufacturers supply written pamplets in the box when one purchases a new device. Unfortunately, these pamplets often get lost or misplaced by the user. Additionally, if multiple members of a family or business use the new device, then only one may review the pamplet at a time. The result is that the features the consumer electronic device industry spent so much effort and time providing to the user ends up never really being appreciated and/or used.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for automatically providing information about a new device to be integrated within a current system configuration, in which some embodiments of the present invention may operate;

FIG. 2 illustrates a possible device identifier, according to an embodiment of the invention;

FIGS. 3A and 3B is a flow diagram of one embodiment of a process for the operation of automatically providing information about a new device to be integrated within a current system configuration;

FIG. 4 is a flow diagram of one embodiment of a process for generating a new device email notification; and

FIG. 5 is a flow diagram of one embodiment of a process for checking the validity of a new device email notification.

### DESCRIPTION OF EMBODIMENTS

According to an embodiment of the invention, a method and system for automatically providing information about a new device to be integrated within a current system configuration are described. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

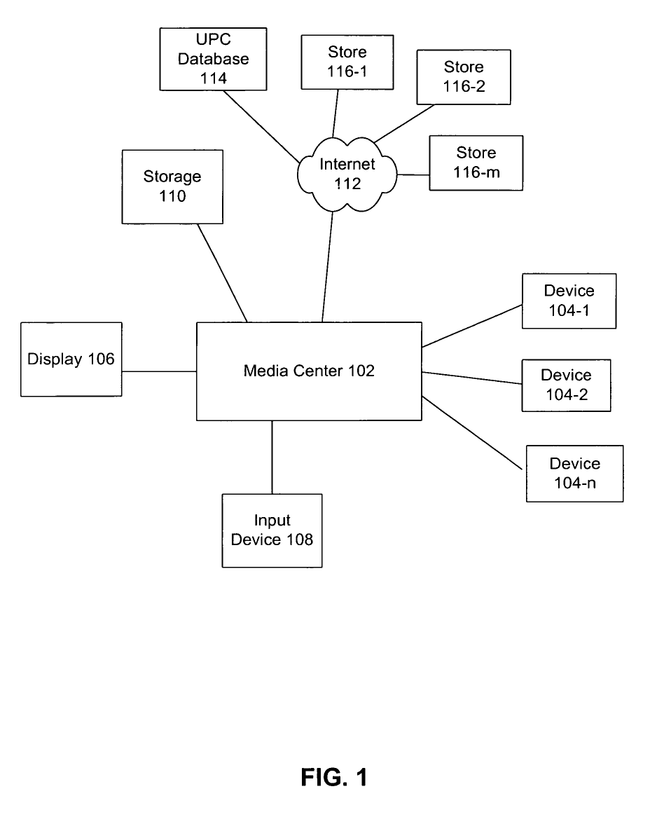

FIG. 1 illustrates one embodiment of an environment for automatically providing information about a new device to be integrated within a current system configuration, in which some embodiments of the present invention may operate. Here, when a user purchases a new device, the user and/or the user's current system configuration may be automatically provided information about the new device. In an embodiment of the invention, an email notification from the store where the user purchased the new device is automatically generated and emailed to an address associated with the user. A host device or media center may identify the new device via information provided in the email notification. Once the new device is identified, the host device may obtain information about the new device. Such information may include, but is not necessarily limited to, a new device greeting, an interactive instructional manual on how to use and/or set-up the device, warranty and registration information, the compatibility of the new device within the user's current system configuration, available accessories for the new device, and so forth.

The specific components shown in FIG. 1 represent one example of a configuration that may be suitable for the invention and is not meant to limit the invention. Referring to FIG. 1, the environment may include, but is not necessarily limited to, a host device or media center 102, one or more devices 104 (shown as device 104-1 through 104-n), a display 106, an input device 108, storage 110, the Internet 112, a Universal Product Code (UPC) database 114 and one or more stores (shown as store 116-1 through 116-m).

In an embodiment of the invention, the environment of FIG. 1 may relate to a consumer electronics digital home environment. Here, host device 102 may be a media center, as illustrated in FIG. 1. Devices 104 may be various consumer electronic devices found in the digital home environment, such as digital televisions, digital video disk (DVD) players, video cassette recorder (VCR) players, compact disk (CD) players, set-top boxes, stereo receivers, media centers, personal video recorders (PVRs), digital cameras, digital camcorders, personal digital assistants (PDAs), printers, and so forth. Stores 116 may be consumer electronic stores. This embodiment is not meant to limit the invention and is provided for illustration purposes only. For example, the environment of FIG. 1 may relate to a digital office or any other environment where digital devices are networked together. Each of the components illustrated in FIG. 1 are described next in more detail.

Media center 102 may be networked together with one or more of the components shown in FIG. 1. Therefore, media center 102 is able to perform status checks on the networked components and determine a current configuration of the system. Media center 102 is used for illustrations purposes only and may be any device that is capable of performing the functionalities described herein. For example, media center 102 could be replaced by a digital television (DTV), a personal computer, and so forth, that is adapted to perform the functionalities described herein. In an embodiment, the network may be an 802.11 wireless network. The network may also be a wired network that uses IEEE 1394 or firewire to connect the various components. The network may also be a combination of a wired and wireless network. Other networks may be added or substituted according to the particular application for the environment in FIG. 1 and/or as new types of networks are developed. These example types of networks are not meant to limit the invention.

Devices 104 may be any electronic device. Examples of devices 104 may include, but are not limited to, digital televisions, DVD players, VCR players, CD players, set-top boxes, stereo receivers, media centers, PVRs, digital cameras, digital camcorders, PDAs, printers, medical devices, and so forth. The present invention is not necessarily limited to typical devices found in a home or office. Although there are n devices shown in FIG. 1, the present invention may include one or more devices.

Display 106 may be any means of communicating information to the user about a newly purchased device. In an embodiment of the invention, display 106 is a screen that displays the information. Input device 108 may be any means of providing information to media center 102.

Storage 110 may be any storage medium that is accessed by media center 102 to retrieve and store information. Storage 110 may store information related to the current system configuration, a device identification database, standard audio/video instructions showing how to configure devices, product information about the devices, instructional information about the devices, and so forth. Media center 102 may have access to the Internet 112 in order to retrieve information from and/or download information to storage 110. Internet 112 may be replaced by any network, including but not limited to, a local area network (LAN), a wide area network (WAN), and so forth. Internet 112 may include a LAN or WAN.

Media center 102 may also interact with one or more of stores 116. Although there are m stores shown in FIG. 1, one or more stores may be associated with the present invention. In an embodiment of the invention, media center 102 may access UPC database 114 in order to identify a new device based on its UPC label.

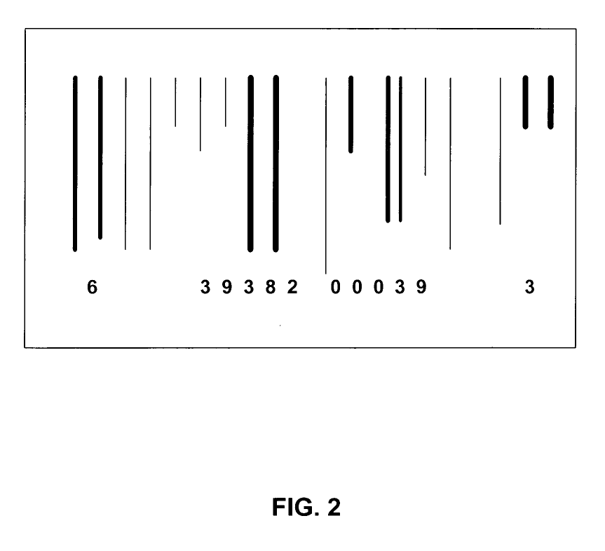

In an embodiment of the invention, a device may be identified by its UPC label. UPCs originate with a company called the Uniform Code Council (UCC). A manufacturer applies to the UCC for permission to enter the UPC system. The manufacturer pays an annual fee for the privilege. In return, the UCC issues the manufacturer a six-digit manufacturer identification number and provides guidelines on how to use it. Referring to FIG. 2, an example standard UPC label is shown. The standard UPC number has two parts, the machine-readable bar code and the human-readable 12-digit UPC number. The first six digits of the UPC number shown in FIG. 2 (639382) is the manufacturer identification. The next five digits (00039) of the UPC number is the item number. Item numbers are assigned to products, making sure the same item number is not used on more than one product and retiring item numbers as products are removed from the product line, etc. The last digit (3) of the UPC number is called a check digit and is used by the scanner to determine whether the number was correctly scanned. In an embodiment of the invention, UPC database 114 may contain a listing of all device UPC label numbers and their corresponding device identity. The example UPC label shown in FIG. 2 is provided for illustration purposes only and is not meant to limit the invention.

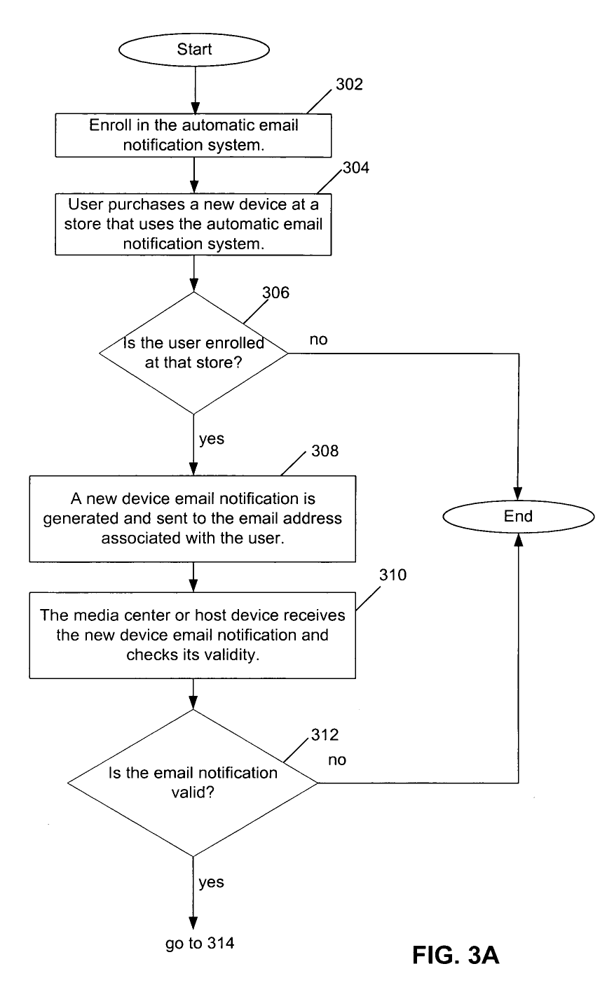

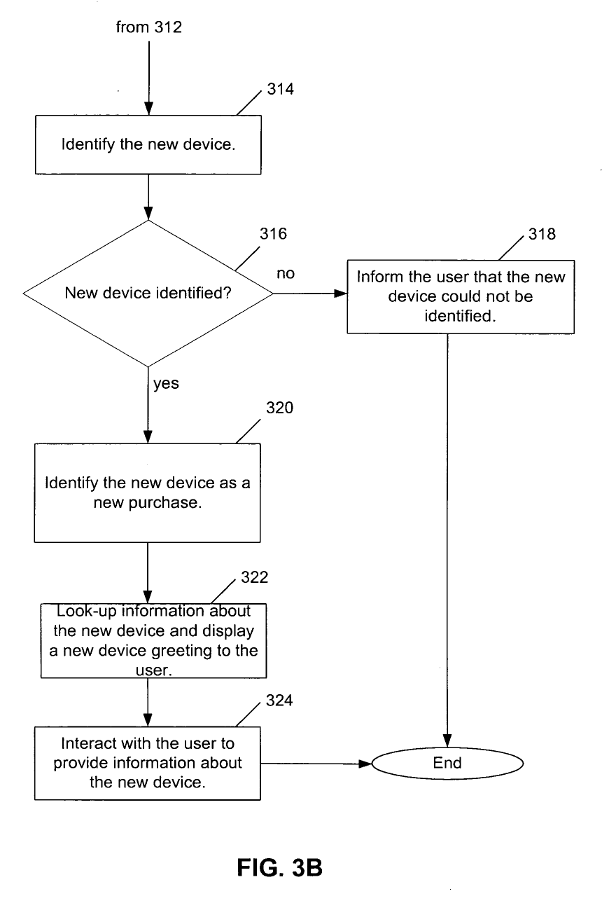

Embodiments of the operation of the present invention are described next with reference to FIGS. 3A, 3B, 4 and 5. The flow diagrams and other descriptions of processes herein are not intended to imply a fixed order of performing the process stages. Rather, the process stages may be performed in any order that is practicable.

FIGS. 3A and 3B is a flow diagram of one embodiment of a process for the operation of automatically providing information about a new device to be integrated within a current system configuration. Referring to FIG. 3A, the process begins at processing block 302 where the user is enrolled in an automatic email notification system. The user may be enrolled in the automatic email notification system in a variety of ways. For example, the user may enroll him or herself by sending an email to stores (such as stores 116-1 through 116-m of FIG. 1) that participate in the automatic email notification system and from which the user may purchase a new device. In an embodiment, the email may include a specific subject line that indicates to the store that the user wants to enroll. The email may include one or more of the user's name, billing address, email address, credit card numbers, debit card numbers, store discount card numbers, telephone number and so forth. This information may be linked to the user and used to determine whether the user is enrolled at the store. In an embodiment of the invention, the user may determine a password to be associated with an email notification sent to the user.

A host device or media center (such as media center 102 of FIG. 1) may also be used to automatically enroll the user at one or more stores. For example, the user may be automatically enrolled at all stores that participate in the automatic email notification system, at only local stores that participate in the automatic email notification system, at favorite stores as indicated by the user, and so forth. In an embodiment of the invention, the host device or media center may automatically determine a password to be associated with an email notification sent to the user. These specific examples of enrolling the user in the automatic email notification system are provided for illustration purposes only and are not meant to limit the invention. In any event, by completing the enrollment process, the user may receive email notifications from the store when he or she purchases a new device, when new information about a previously purchased device becomes available, and so forth.

At processing block 304, the user purchases a new device at a store that participates in the automatic email notification system. The user may physically visit the store to purchase the device or purchase the device on-line. At decision block 306, it is determined whether the user is enrolled at that particular store. For example, the store may link the user's credit cards, debit cards, store discount cards, telephone number, and so forth, to the automatic email notification system. Thus, when the user uses one of the linked cards or provides his or her telephone number to purchase the new device, the store may automatically use that information to search a database to determine whether the user is enrolled at the store. These example ways of determining whether the user is enrolled at the particular store are provided for illustration purposes only and are not meant to limit the invention. If the user is not enrolled at the store, then the flow diagram of FIGS. 3A and 3B ends at this point. If the user is enrolled at the store, then the flow may continue at processing block 308.

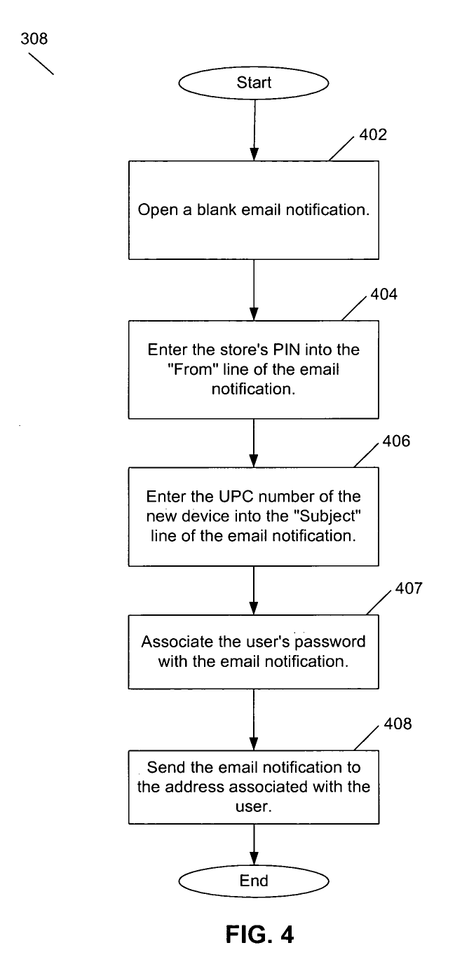

At processing block 308, a new device email notification is generated by the store and sent to the email address associated with the user (e.g. sent to media center 102). Processing block 308 is described below in more detail with reference to FIG. 4.

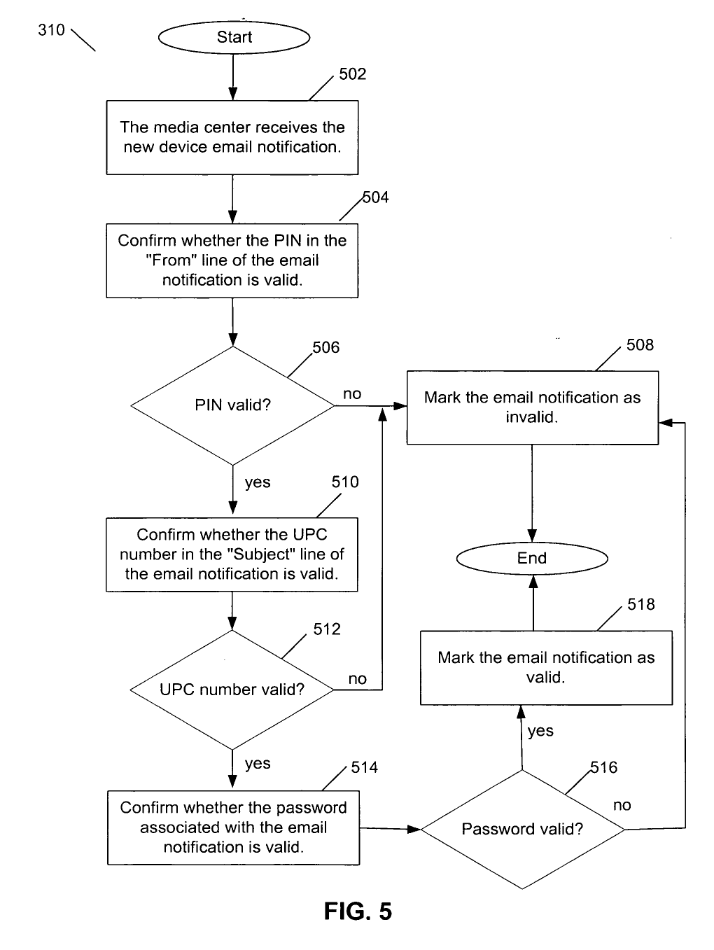

The media center receives the new device email notification and checks its validity at processing block 310. In an embodiment of the invention, checking the validity of the email notification helps to ensure against the possibility of being bombarded with fake emails indicating new device purchases. Processing block 310 is described below in more detail with reference to FIG. 5.

At decision block 312, if the email notification is not valid then the flow diagram of FIGS. 3A and 3B ends at this point. If the email notification is valid, then the media center identifies the new device at processing block 314 (FIG. 3B). In an emodiment of the invention, the email notification may include the UPC number of the new device. The UPC number may be used by the media center to identify the new device via a UPC database (such as UPC database 114 of FIG. 1).

If at decision block 316 the new device cannot be identified, then the user is informed that the new device cannot be identifed at processing block 318 and the flow diagram of FIGS. 3A and 3B ends at this point. If the new device can be identified, then the new device is identified as a new purchase at processing block 320. Here, the new device may be added to a list of devices owned by the user, the current system configuration may be updated to include the new device, and so forth.

Once the new device is identified, then at processing block 322, the media center has access to information about the new device and may display a new device greeting to the user via a display (such as display 106 of FIG. 1). Information about the new device may be stored locally, for example in storage 110 of FIG. 1, or may be stored remotely and accessed via the Internet. Stored information may include, but is not necessarily limited to, an interactive instructional manual on how to use and/or set-up the device, warranty and registration information, the compatibility of the new device within the user's current system configuration, available accessories for the new device, and so forth.

At processing block 324, the user may interact with the media center via an input device (such as device 108 of FIG. 1) to receive information about the new device. Such information may include, but is not necessarily limited to, a new device greeting, an interactive instructional manual on how to use and/or set-up the device, warranty and registration information, the compatibility of the new device within the user's current system configuration, available accessories for the new device, and so forth. The flow diagram of FIGS. 3A and 3B ends at this point.

FIG. 4 is a flow diagram of one embodiment of a process for generating a new device email notification (processing block 308 of FIG. 3A). The embodiment described in FIG. 4 is only one possible way of generating a new device email notification and is not meant to limit the invention.

Referring to FIG. 4, the process begins at processing block 402 where a blank email notification is automatically opened by the store. The store's PIN is entered into the “From” line of the email notification and the UPC number of the new device is entered into the “Subject” line of the email notification, at processing blocks 404 and 406 respectively. At processing block 407, the user's password is associated with the email notification. At processing block 408, the email notification is automatically sent to the email address associated with the user. The flow diagram of FIG. 4 ends at this point.

FIG. 5 is a flow diagram of one embodiment of a process for checking the validity of a new device email notification (processing block 310 of FIG. 3A). The embodiment described in FIG. 5 is only one possible way of checking the validity of the new device email notification and is not meant to limit the invention.

Referring to FIG. 5, the process begins at processing block 502 where the media center receives the new device email notification. The media center then confirms that the PIN in the “From” line of the email notification is valid at processing block 504. For example, the media center may store or have access to a database containing all valid PINs for stores participating in the automatic email notification system.

At decision block 506, if the PIN is not valid, then the email notification is marked as invalid at processing block 508. The flow diagram in FIG. 5 ends at this point. Alternatively, if the PIN is valid, then at processing block 510 the media center confirms whether the UPC number in the “Subject” line of the email notification is valid. For example, media center may store or have access to a database (such as UPC database 114 of FIG. 1) containing all valid UPC numbers for products of stores participating in the automatic email notification system.

At decision block 512, if the UPC number is not valid, then the email notification is marked as invalid at processing block 508. The flow diagram in FIG. 5 ends at this point. Alternatively, if the UPC number is valid, then at processing block 514 the media center confirms whether the password associated with the email notification is valid. For example, the media center may have stored the password generated for the user in storage (such as storage 110 of FIG. 1). The media center may compare the stored password with the password associated with the email notification.

At decision block 516, if the password is not valid, then the email notification is marked as invalid at processing block 508. The flow diagram in FIG. 5 ends at this point. Alternatively, if the password is valid, then at processing block 518 the media center marks the email notification as valid. The flow diagram in FIG. 5 ends at this point.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
receiving a new device email notification, wherein the new device email notification is automatically generated at a store when a user purchases a new device;
validating the new device email notification;
identifying the new device via the new device email notification; and
providing information about the identified new device.

2. The method of claim 1, wherein the new device email notification includes one or more of a store identifier, a new device identifier and a password.

3. The method of claim 2, wherein the new device identifier is a Universal Product Code (UPC) number.

4. The method of claim 3, wherein the UPC number is used to identify the new device via a UPC database.

5. The method of claim 2, wherein validating the new device email notification comprises confirming that the store identifier and the new device identifier are valid.

6. The method of claim 5, wherein validating the new device email notification further comprises confirming that the password is valid.

7. The method of claim 1, further comprising enrolling the user in an automatic email notification system.

8. The method of claim 7, wherein the user is enrolled in the automatic email notification system via a host device.

9. A system comprising:
a host device; and
one or more existing devices, wherein the host device and the one or more existing devices are networked together via a current system configuration, wherein the host device receives a new device email notification, wherein the new device email notification is automatically generated at a store when a user purchases a new device, wherein the host device validates the new device email notification, wherein the host device identifies the new device via the new device email notification, and wherein the host device provides information about the identified new device.

10. The system of claim 9, wherein the host device is a media center and wherein the one or more devices and the new device are consumer electronic devices.

11. The system of claim 9, wherein the new device email notification includes one or more of a store identifier, a new device identifier and a password.

12. The system of claim 11, wherein the new device identifier is a Universal Product Code (UPC) number.

13. The system of claim 12, wherein the UPC number is used to identify the new device via a UPC database.

14. The system of claim 11, wherein the host device validates the new device email notification by confirming that the store identifier and the new device identifier are valid.

15. The system of claim 14, wherein the host device further validates the new device email notification by confirming that the password is valid.

16. The system of claim 9, wherein the host device enrolls the user in an automatic email notification system.

17. A machine-readable medium containing instructions which, when executed by a processing system, cause the processing system to perform a method, the method comprising:
receiving a new device email notification, wherein the new device email notification is automatically generated at a store when a user purchases a new device;
validating the new device email notification;
identifying the new device via the new device email notification; and
providing information about the identified new device.

18. The machine-readable medium of claim 17, wherein the new device email notification includes one or more of a store identifier, a new device identifier and a password.

19. The machine-readable medium of claim 18, wherein the new device identifier is a Universal Product Code (UPC) number.

20. The machine-readable medium of claim 19, wherein the UPC number is used to identify the new device via a UPC database.

21. The machine-readable medium of claim 18, wherein validating the new device email notification comprises confirming that the store identifier and the new device identifier are valid.

22. The machine-readable medium of claim 21, wherein validating the new device email notification further comprises confirming that the password is valid.

23. The machine-readable medium of claim 17, further comprising enrolling the user in an automatic email notification system.

24. The machine-readable medium of claim 23, wherein the user is enrolled in the automatic email notification system via a host device.
